(19) United States
(12) Patent Application Publication
(10) Pub. No.: US 2015/0293670 A1
(43) Pub. Date: Oct. 15, 2015

(54) METHOD FOR OPERATING MESSAGE AND ELECTRONIC DEVICE THEREFOR

(71) Applicant: Samsung Electronics Co., Ltd., Gyeonggi-do (KR)

(72) Inventors: Han-Jib KIM, Gyeonggi-do (KR); Doo-Suk KANG, Gyeonggi-do (KR)

(21) Appl. No.: 14/684,525

(22) Filed: Apr. 13, 2015

(30) Foreign Application Priority Data
Apr. 14, 2014 (KR) 10-2014-0044229

(51) Int. Cl. G06F 3/0484; H04L 12/58

(52) U.S. Cl. CPC G06F 3/04842; H04L 51/04; H04L 51/10; G06F 3/04847

(57) ABSTRACT

A method for operating an electronic device is provided. The method includes transmitting and receiving messages with at least one first external electronic device through a chat window. In response to the user selecting at least some of the transmitted and received messages, the electronic device transmits a chat invitation request including the selected messages to at least one second external electronic device.

### CLAIM OF PRIORITY

The present application is related to and claims the benefit under 35 U.S.C. §119(a) from Korean Patent Application No. 10-2014-0044229 filed in the Korean Intellectual Property Office on Apr. 14, 2014, the entire disclosure of which is hereby incorporated by reference in its entirety.

### BACKGROUND

1. Field of the Disclosure

The present disclosure relate to a method for operating message and an electronic device thereof.

2. Description of the Related Art

With the rapid development of information technology, communication technology and semiconductor technology, various electronic devices have evolved into multimedia devices that provide a plurality of multimedia services that used to require separate devices, if at all. Examples of some of the plurality of multimedia services provided by an electronic device include a messenger service, a broadcasting service, a wireless Internet service, a camera service, a music playback service, and the like.

A multimedia message service (MMS) has been provided that permits much more than the transmission of simple text messages by the combining of the advantages of a short message service (SMS) with the advantages of an email service. MMS is a message service that enables a user to transmit and receive a combination of a text, music, an image, a video, link information, and the like. Due to the development of these message functions, an electronic device has been provided a chat type message function that enables a plurality of users to transmit and receive messages among themselves through a chat window.

The chat type message function shows messages transmitted and received through a chat window only to users currently participating in the chat, and a user who joins the chat after the corresponding chat has been opened may not know what the existing users have chatted about because the chat transcript before his/her joining the chat is not shown to him/her. Contrarily, when the previous chat transcript is transferred over again to a user who newly joins the chat, this imposes unnecessary information repetition and the discontinuance of the chat on the existing participants. Therefore, there is a need in the art to provide in an electronic device a message service for facilitating communication between the existing participants of a chat and a newly joining participant to the chat.

### SUMMARY

An aspect of the present disclosure is related to an electronic device and a method of operation to provide messages that are transmitted and received with at least one first external electronic device through a chat window to a second external electronic device in an electronic device.

Another aspect of the present disclosure is related to an electronic device and method of operation to provide messages by displaying a chat transcript transferred from another electronic device.

Another aspect of the present disclosure is related to an electronic device and a method of operation to provide messages for facilitating communication between the existing participants of a chat and a newly joining participant to the chat in an electronic device.

In accordance with still another aspect of the present disclosure, a method for operating an electronic device is provided. The method may include transmitting and receiving messages with at least one first external electronic device through a chat window, selecting at least some of the transmitted and received messages, and transmitting a chat invitation request including the selected messages to at least one second external electronic device.

In accordance with an aspect of the present disclosure, an electronic device is provided. The electronic device includes a display module that is functionally connected to the electronic device, and a processor that is configured to transmit and receive messages with at least one first external electronic device through a chat window, to detect a selection of at least some of the transmitted and received messages, and to transmit a chat invitation request including the selected messages to at least one second external electronic device.

In accordance with yet another aspect of the present disclosure, a method for operating an electronic device is provided. The method includes receiving a chat invitation request including messages from at least one external electronic device, and displaying the messages included in the chat invitation request.

According to various embodiments of the present disclosure, communication are facilitated between the existing participants of a chat and a newly joining participant to the chat by providing messages transmitted and received with at least one first external electronic device to at least one second external electronic device in an electronic device. For example, a user of an electronic device can transfer the previous transcript of a chat between the existing participants to the counterparty at the time he/she transmits a chat invitation request to the counterparty, and therefore the new participant (i.e., counterparty) can join the chat window after having identified the chat transcript in advance, and thus can be “up to speed” with regard to the previous areas of conversation. Furthermore, by transferring the previous chat transcript to the counterparty, the user can selectively transfer a part of the chat transcript on the basis of the user's intention, and does not have to transfer the entire chat. In addition, since there is no need to synchronize the screens of the existing participants and the new participant, the convenience of the chat function can be enhanced.

According to various embodiments of the present disclosure, a method for operating an electronic device may include: transmitting and receiving messages with at least one first external electronic device through a chat window; selecting at least some of the transmitted and received messages; and transmitting a chat invitation request including the selected messages to at least one second external electronic device.

According to various embodiments of the present disclosure, the method may further include determining the second external electronic device before or after the selecting of the at least some of the transmitted and received messages.

According to various embodiments of the present disclosure, the determining of the second electronic device may include determining whether information on the second external electronic device is stored in the electronic device.

According to various embodiments of the present disclosure, the selecting of the at least some of the transmitted and received messages may include selecting the at least some of the transmitted and received messages on the basis of at least one of a chat topic, a chat participant, a message transmission/reception time, the number of messages, and user settings.

According to various embodiments of the present disclosure, the selecting of the at least some of the transmitted and received messages on the basis of the chat topic may include searching for messages associated with a specific word among the transmitted and received messages, messages in other chat windows, or grouped messages.

According to various embodiments of the present disclosure, the selecting of the at least some of the transmitted and received messages on the basis of the user settings may include setting a range of the at least some of the transmitted and received messages.

According to various embodiments of the present disclosure, the setting of the range of the at least some of the transmitted and received messages may include setting at least one location of the transmitted and received messages by a drag over a certain distance.

According to various embodiments of the present disclosure, the setting of the range of the at least some of the transmitted and received messages may include setting at least one location of the transmitted and received messages as a starting point or end point of the range.

According to various embodiments of the present disclosure, a method for operating an electronic device may include: receiving a chat invitation request including messages from at least one external electronic device; and displaying the messages included in the chat invitation request.

According to various embodiments of the present disclosure, the displaying of the messages may include displaying the messages along with the chat invitation request.

According to various embodiments of the present disclosure, the displaying of the messages may include displaying messages using at least one of a folder, a link, and a popup.

According to various embodiments of the present disclosure, the displaying of the messages may include displaying the messages in at least a partial area of a chat window.

### BRIEF DESCRIPTION OF THE DRAWINGS

The above and other aspects, features, and advantages of the present disclosure will become more apparent to a person of ordinary skill in the art from the following detailed description taken in conjunction with the accompanying drawings, in which:

FIG. 1 is a structural block diagram of an electronic device according to an embodiment of the present disclosure;

FIG. 2 is a flowchart illustrating an operational procedure of providing messages transmitted and received with a second electronic device to a third electronic device in an electronic device according to an embodiment of the present disclosure;

FIG. 3A, FIG. 3B, FIG. 3C, FIG. 3D, FIG. 3E and FIG. 3F are screen shots illustrating respective examples of providing messages transmitted and received with a second electronic device to a third electronic device in an electronic device according to an embodiment of the present disclosure;

FIG. 4 is a flowchart illustrating an operational procedure of providing messages transmitted and received with a second electronic device to a third electronic device in an electronic device according to an embodiment of the present disclosure;

FIG. 5A, FIG. 5B, FIG. 5C, FIG. 5D, FIG. 5E, FIG. 5F and FIG. 5G are screen shots illustrating an example of providing messages transmitted and received with a second electronic device to a third electronic device in an electronic device according to an embodiment of the present disclosure;

FIG. 6 is a flowchart illustrating an operational procedure of displaying a chat transcript transferred from another electronic device in an electronic device according to an embodiment of the present disclosure;

FIG. 7A, FIG. 7B, FIG. 7C and FIG. 7D are respective screen shots illustrating an example of displaying a chat transcript transferred from another electronic device in an electronic device according to an embodiment of the present disclosure; and

FIG. 8 is a structural block diagram of an electronic device according to various embodiments of the present disclosure.

### DETAILED DESCRIPTION

The following description with reference to the accompanying drawings is provided to assist a person of ordinary skill in the art with a comprehensive understanding of various embodiments of the present disclosure as defined by the claims and their equivalents. Although the present disclosure is described in detail in conjunction with particular embodiments illustrated in the drawings, the present does not limit the claimed subject matter to what is shown and described, and various modifications and changes may be made therein. Accordingly, the present disclosure is not limited to particular forms, and the person of ordinary skill in the art should understand that the present disclosure covers all modifications and changes, equivalents, and alternatives falling within the spirit and scope of the present disclosure. In describing the drawings, similar reference numerals are typically used to designate similar elements.

An electronic device according to the present disclosure is not limited to a device shown in the drawings, and may include any of: a smart phone; a tablet personal computer (PC); a mobile phone; a video phone; an electronic book (e-book) reader; a desktop PC; a laptop PC; a netbook computer; a personal digital assistant (PDA); a portable multimedia player (PMP); an MP3 player; accessories; an electronic appcessory; a camera; a wearable device; a wristwatch; a refrigerator; an air conditioner; a vacuum cleaner; an artificial intelligence robot; a television (TV); a digital video disk (DVD) player; an audio; an oven; a microwave oven; a washing machine; an electronic bracelet; an electronic necklace; an air cleaner; an electronic photo frame; medical appliances; navigation equipment; a global positioning system (GPS) receiver; an event data recorder (EDR); a flight data recorder (FDR); a set-top box; a TV box; an electronic dictionary; an in-vehicle infotainment device; electronic equipment for ships; avionics; security equipment; electronic clothes; an electronic key; a camcorder; a game console; a head-mounted display (HMD); a flat panel display device; an electronic album; a part of furniture or a building/structure including an electronic device; an electronic board; an electronic signature receiving device; and a projector, just to name a few non-limiting possibilities. Further, it will be apparent to those skilled in the art that the electronic device according to the present disclosure is not limited to the above-mentioned devices.

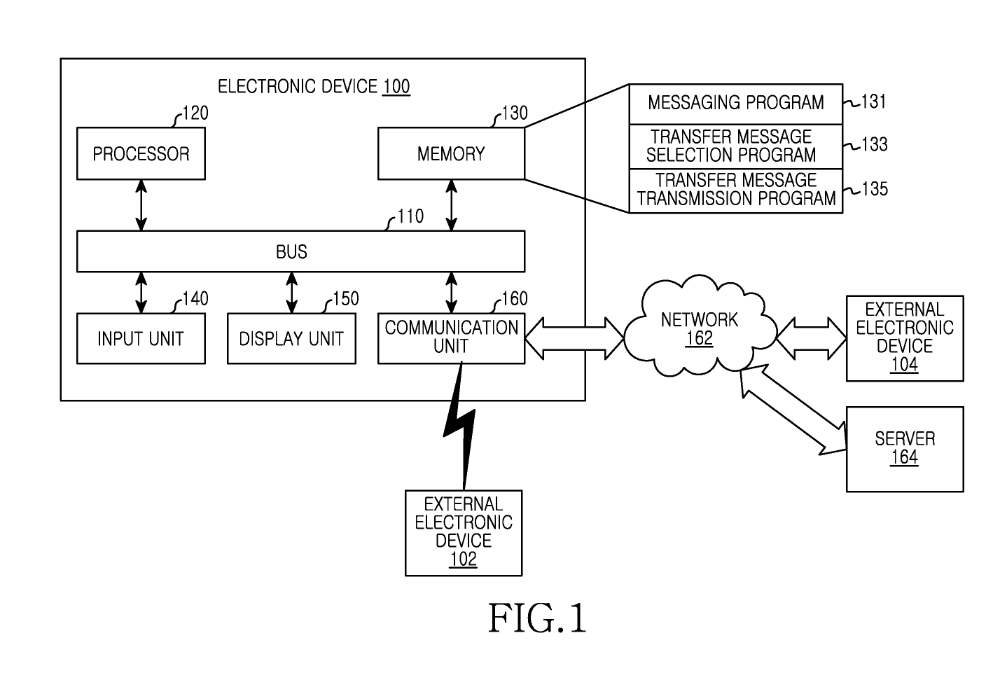

FIG. 1 illustrates, in a structural block diagram, an electronic device according to an embodiment of the present disclosure.

Referring now to FIG. 1, the electronic device 100 may include a bus 110, a processor 120, a non-transitory memory 130, an input unit 140, a display unit 150, and a communication unit 160.

The bus 110 may interconnect the elements (e.g., the processor 120, the non-transitory memory 130, the input unit 140, the display unit 150, and the communication unit 160) included in the electronic device 100 and may control communication between the elements.

The processor 120 comprises hardware circuitry configured for operation and may receive commands from the elements included in the electronic device 100, interpret the received commands, and perform calculations or data processing according to the interpreted commands. In this control function, the processor 120 may execute at least one program stored in the non-transitory memory 130 so as to provide a service corresponding to the program. For example, the processor 120 may execute a messaging program 131, a transfer message selection program 133, and a transfer message transmission program 135 so as to transmit and receive messages with at least a second electronic device through a chat window, select at least some of the transmitted and received messages, and transmit a chat invitation request including the selected messages to at least a third electronic device. Hardware such as microprocessors, processors, etc., may be configured for operation.

The processor 120 may include at least one application processor (AP) or at least one communication processor (CP). Here, the AP and the CP may be included in the processor 120 or may be included in different IC packages respectively. Further, the AP and the CP may be included in one IC package.

The AP may control a plurality of hardware or components of machine executable code connected to the AP, and may perform various data processing and calculations including multimedia data processing and calculation by driving an operating system or application programs. Here, the AP may be implemented as a system on chip (SoC).

The CP may perform at least some of multimedia control functions. Further, the CP may perform terminal identification and authentication in a communication network using a subscriber identification module (e.g., a SIM card). In the multimedia control functions, the CP may provide services including a voice call service, a video call service, a text message service, and a packet data service to a user. Further, the CP may control data transmission and reception in the communication unit 160.

The AP or the CP may load a command or data received from at least one of a non-volatile memory and other elements connected to each of the AP and the CP into a volatile memory and may process the loaded command or data. The AP or the CP may store data received from or generated by at least one of other elements in a non-volatile memory.

The CP may manage a data link in communication between an electronic device including hardware and other electronic devices connected to the electronic device over a network and may perform a function of converting a communication protocol. Here, the CP may be implemented as an SoC.

The processor 120, which is hardware such as a semiconductor with circuitry configured for operation may include at least one data processor, image processor, and CODEC. Further, the electronic device 100 may also include a separate data processor, image processor, or CODEC. The processor may be part of a controller or control unit, and may communicate with microprocessors, microcontrollers, or the processor may control most of the operations of the electronic device.

Additionally, the processor 120 may further include a graphics processing unit (GPU).

The non-transitory memory 130 may store commands or data received from or generated by at least one element (e.g., the processor 120, the input unit 140, the display unit 150, or the communication unit 160) included in the electronic device 100.

The non-transitory memory 130 may store at least one program for services of the electronic device 100. For example, the non-transitory memory 130 may contain a messaging program 131, a transfer message selection program 133, and a transfer message transmission program 135. With regard to transfer message selection, each program may include programming modules.

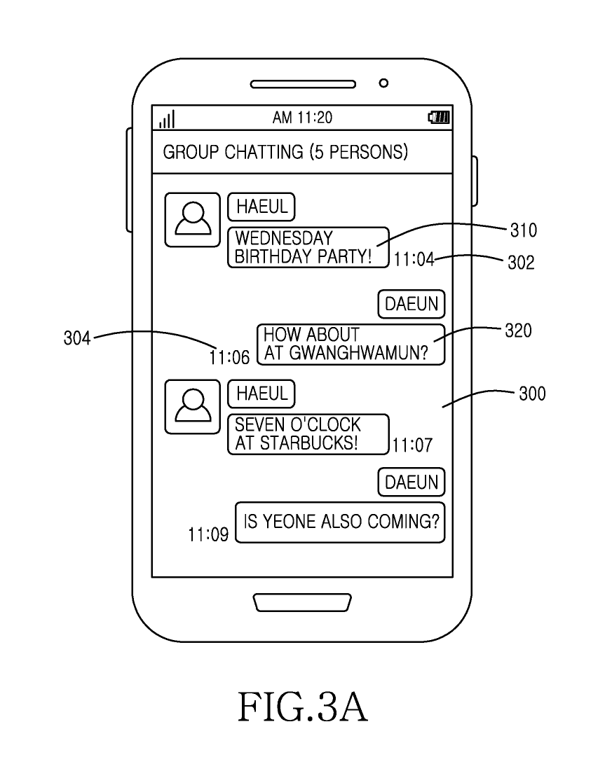

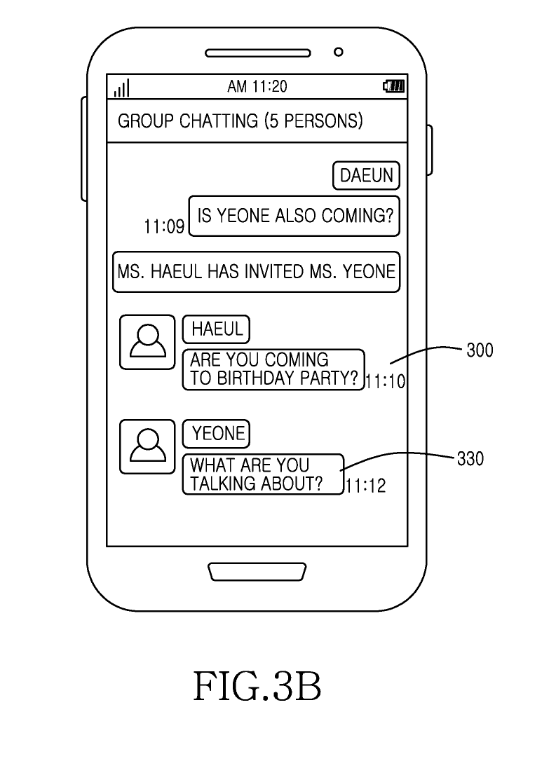

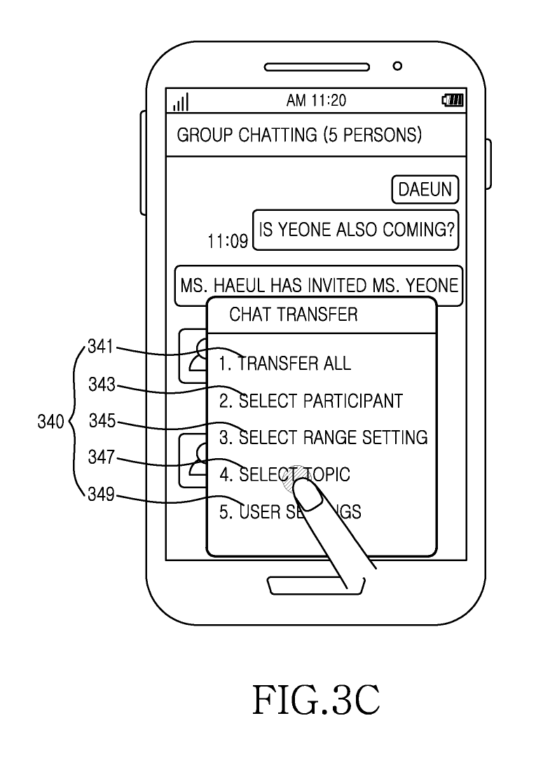

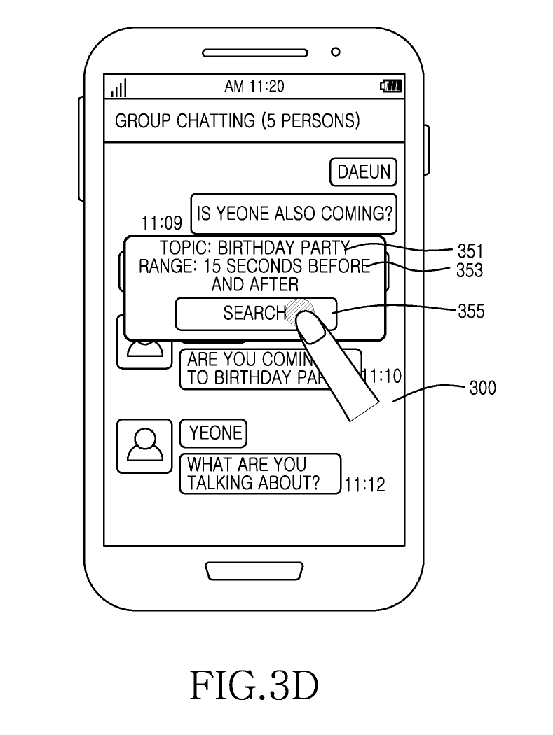

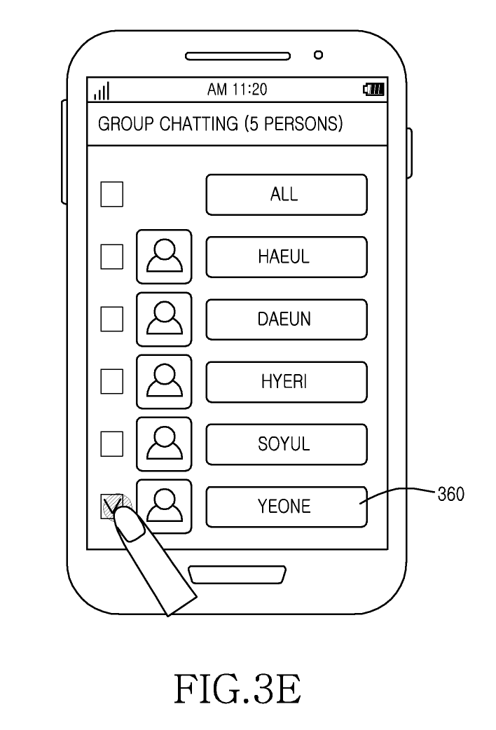

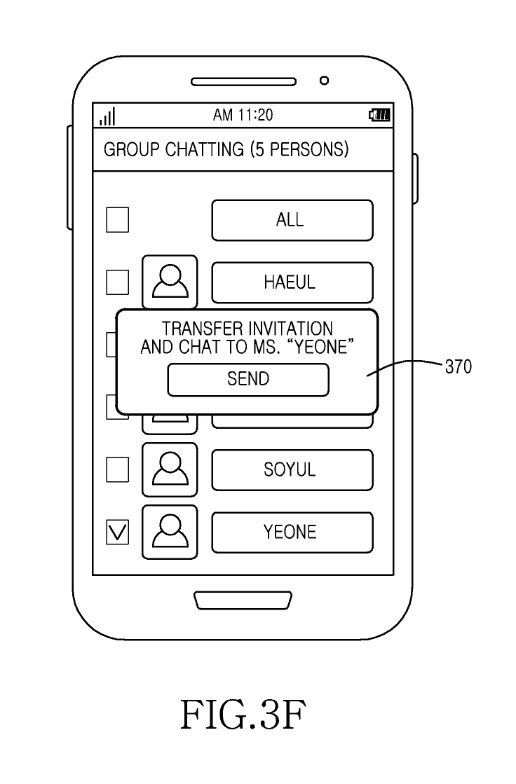

The messaging program 131 may include at least component of machine executable code for transmitting and receiving messages with another electronic device (e.g., an external electronic device) through a chat window. The messaging program 131 may include a messenger program that enables access to a second electronic device and another electronic device, that is, a third electronic device. For example, as shown in FIG. 3A, the messaging program 131 may receive a message 310 from a user of another electronic device or in response to commands transmit a message 320 to another electronic device through a chat window 300. Messaging program 131 may display receiving time 302 of the message 310 received from a user of another electronic device. Also, messaging program 131 may display transmitting time 304 of the message 320 transmitted to another electronic device.

The transfer message selection program 133 may include at least one component of machine executable code to select messages to be transferred to another electronic device (e.g., an external electronic device). The transfer message selection program 133 may select messages transmitted and received through the current chat window, may select messages transmitted and received through another chat window, or may select previously grouped messages. For example, the transfer message selection program 133 may select the entire chat transcript in a chat window, or may select portions of the transcript of the chat, such as may select the transcript of a chat with a certain participant, and may select any part of a chat transcript. However, the present disclosure is not limited thereto, and the transfer message selection program 133 may select messages on the basis of various criteria.

The transfer message transmission program 135 may include at least one component of machine executable code to transmit messages to be transferred to another electronic device. For example, the transfer message transmission program 135 may transmit messages selected through a chat window to the certain participants of a chat, or users who may be invited to the chat, or users registered in a phonebook. Further, the non-transitory memory 130 may include an internal memory or an external memory.

The internal memory may include at least one of a volatile memory (e.g., DRAM, SRAM, or SDRAM) and a non-volatile memory (e.g., OTPROM, PROM, EPROM, EEPROM, mask ROM, flash ROM, NAND flash memory, or NOR flash memory). The internal memory may also be in the form of a solid state drive (SSD).

The external memory may include, for example, at least one of a compact flash (CF), a secure digital (SD), a micro secure digital (Micro-SD), a mini secure digital (Mini-SD), an extreme digital (xD), or a memory stick, just to name some non-limiting possibilities.

In addition, the non-transitory memory 130 may further include a kernel, middleware, an application programming interface (API), and an application. The kernel may control or manage system resources (e.g., the bus 110, the processor 120, or the non-transitory memory 130) that are used to perform operations or functions implemented in all the other programming modules (e.g., the middleware, the API, or the application). Further, the kernel may provide an interface that allows the middleware, API, or the application to access each element of the electronic device 100 and to control or manage the element.

The middleware may act as an intermediary so as to allow the API or the application to communicate with and exchange data with the kernel. Further, the middleware may perform load balancing for operation requests received from at least one application by using a method of prioritizing the operation requests in using system resources (e.g., the bus 110, the processor 120, or the non-transitory memory 130 of the electronic device 100.

The API corresponds to an interface that can control a function provided by the kernel or the middleware and may include at least one interface or function for a file control, a window control, image processing, or a text control.

The input unit 140 may transmit commands or data generated by a user's selection to the processor 120 or the memory 130 via the bus 110. For example, the input unit 140 may include a touch panel, a pen sensor, a key, a ultrasonic input device, or any other pointer device.

The touch panel that recognizes a touch input may include at least one of a capacitive touch panel, a resistive touch panel, an infrared touch panel, and an ultrasonic touch panel. The capacitive touch panel is able to recognize both a proximity touch as well as a direct contact of the touch panel. The proximity touch may also be referred to as a non-contact touch or hovering. The touch panel may further include a tactile layer for providing a tactile reaction to a user. The touch panel may further include a controller.

The display unit 150 may display a picture, an image, or output data to a user. The display unit 150 may include a touch panel for simultaneously performing both input and display functions. The touch panel may include, for example, a liquid crystal display (LCD) or an active matrix organic light emitting diode (AM-OLED) and may be implemented to be flexible, transparent, or wearable.

The display unit 150 may include a hologram device, and the hologram device may show a stereoscopic image in the air using light interference. The display unit 150 may further include a control circuit for controlling the touch panel or the hologram device.

The communication unit 160 may establish a communication connection between the electronic device 100 and one or more other external electronic devices 102 or 104, or between the electronic device 100 and a server 164. The communication unit 160 may support a short range communication protocol (e.g., wireless fidelity (Wi-Fi), Bluetooth (BT), near field communication (NFC)) or a network communication 162 (e.g., Internet, local area network (LAN), wide area network (WAN), telecommunication network, cellular network, satellite network, or plain old telephone service (POTS)).

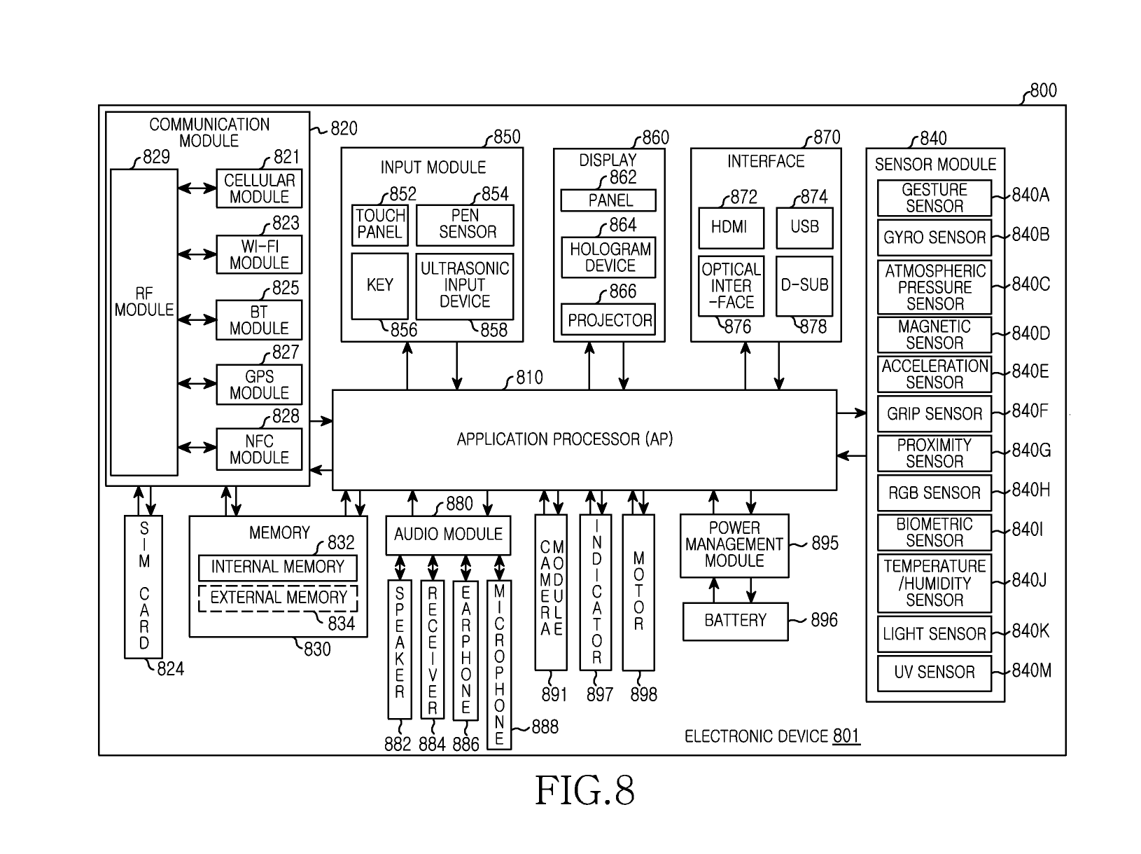

Additionally, the electronic device 100 may further include a sensor module 840 (FIG. 8). The sensor module may include at least one of a gesture sensor, a gyro sensor, an atmospheric pressure sensor, a magnetic sensor, an acceleration sensor, a grip sensor, a proximity sensor, a biometric sensor, a superconducting sensor, a temperature sensor, a humidity sensor, a light sensor, and an ultraviolet (UV) sensor.

Further, the sensor module may measure a physical quantity or sense an operational state of the electronic device 100, and may convert the measured or sensed information into an electric signal. For example, the sensor module may include an E-nose sensor, an electromyography (EMG) sensor, an electroencephalogram (EEG) sensor, an electrocardiogram (ECG) sensor, or a fingerprint sensor, just to name some non-limiting possibilities.

The names of elements of the electronic device 100 according to various embodiments of the present disclosure may vary depending on the type of electronic device 100. Further, the electronic device 100 may include at least one of the above described elements, exclude some of the elements, or further include additional other elements depending on the type of electronic device 100.

According to various embodiments of the present disclosure, an electronic device may include: a display module that is functionally connected to the electronic device; and a processor that is configured to transmit and receive messages with at least one first external electronic device through a chat window, select at least some of the transmitted and received messages, and transmit a chat invitation request including the selected messages to at least one second external electronic device.

According to various embodiments of the present disclosure, the processor may be configured to determine whether information about the second external electronic device is stored in the electronic device.

According to various embodiments of the present disclosure, the processor may be configured to select one or more of the transmitted and received messages on the basis of a chat topic, a chat participant, a message transmission/reception time, the number of messages, or user settings.

According to various embodiments of the present disclosure, the processor may be configured to search for messages associated with a specific word among the transmitted and received messages, messages in other chat windows, or grouped messages on the basis of the chat topic.

According to various embodiments of the present disclosure, the processor may be configured to set a range of the at least some of the transmitted and received messages on the basis of the user settings.

According to various embodiments of the present disclosure, the processor may be configured to set at least one location of the transmitted and received messages by a dragging over a certain distance.

According to various embodiments of the present disclosure, the processor may be configured to set at least one location of the transmitted and received messages as a starting point or ending point of the range.

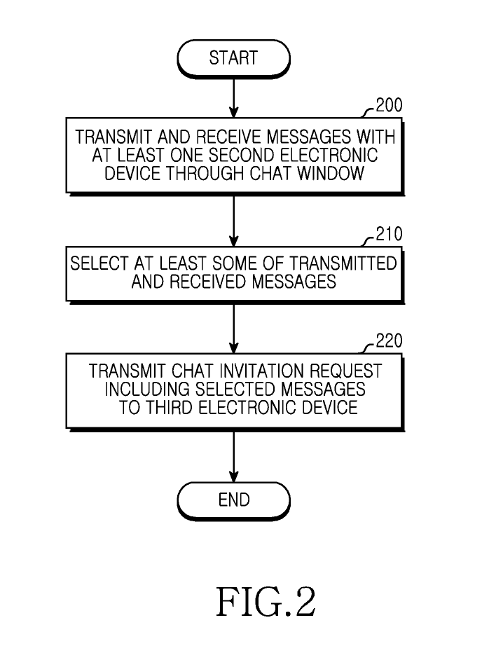

FIG. 2 is a flowchart that illustrates an operational procedure of providing messages transmitted and received with a second electronic device to a third electronic device in an electronic device according to an embodiment of the present disclosure.

Referring now to FIG. 2, at operation 200, the electronic device 100 may transmit and receive messages with at least one second external electronic device 102, through a chat window. Here, the chat window may include a messenger program that enables access to the second electronic device and another electronic device, that is, a third electronic device 104, but the present disclosure is not limited thereto. For example, as shown in FIG. 3A, the electronic device may receive a message 310 from the second external electronic device 102 or transmit a message 320 to the second external electronic device 102 through a chat window 300. According to various embodiments of the present disclosure, the electronic device or the second electronic device may transmit, to the third electronic device, a chat invitation request for inviting the third electronic device to the chat window 300. For example, as shown in FIG. 3B, the electronic device may receive a message 330 from the third electronic device or transmit a message to the third electronic device when the third electronic device joins the chat window in response to the chat invitation request.

At operation 210, the electronic device may select at least some of the transmitted and received messages. For example, the electronic device may select all or some of the messages transmitted and received with the second electronic device according to certain criteria. According to an embodiment of the present disclosure, the electronic device may select messages on the basis of at least one of a chat topic, a chat participant, a message transmission/reception time, the number of messages, and user settings.

For example, as shown in FIG. 3C, the electronic device may choose a function 341 for selecting the entire chat transcript, a function 343 for selecting the transcript of a chat with just a specific participant, a function 345 for setting the starting point or end point of a chat transcript, a function 347 for selecting the transcript of a chat including a specific topic or specific contents, or a function 349 for selecting a chat transcript through user settings. However, the present disclosure is not limited thereto, and in addition to the above described specific functions 340, there may be functions corresponding to various criteria such as a specific time, a specific place, and the participation time of a specific participant.

For example, with continued reference to FIG. 3C, when the topic selection function 347 is chosen from among the specific functions 340, the electronic device may receive, through a user input, a chat topic 351 to be transferred as shown in FIG. 3D. Also, electronic device may search for messages corresponding to the input chat topic 351 by selecting a search icon 355. When the chat topic 351 is input, a range 353 (in this case 15 seconds before and after) associated with the input chat topic 351 may also be input, and the associated range 353 may be set on the basis of various criteria such as a chat time period, a specific time, a specific place, and the number of messages. According to various embodiments of the present disclosure, the electronic device may search for messages associated with a specific word among messages transmitted and received through the chat window 300, messages in other chat windows, or grouped messages.

At operation 220, the electronic device 100 may transmit a chat invitation request including the selected messages to the third electronic device. According to an embodiment of the present disclosure, the electronic device may determine which is the third electronic device before or after selecting at least some of the transmitted and received messages. For example, as shown in FIG. 3E, the electronic device may select a participant 360 to whom to transmit a chat invitation request including the selected messages. As shown in FIG. 3F, upon completion of selecting the participant 360, the electronic device may output a chat invitation confirmation window 370. According to various embodiments of the present disclosure, the electronic device may also transmit a chat invitation request including the selected messages to at least one other electronic device. Thus, new participants can be added to the chat but at the same time, be knowledgeable about what has previously been discussed. t

Although the electronic device according to various embodiments of the present disclosure has been described as transmitting only messages transmitted and received through a chat window to another electronic device (i.e. external device), the present disclosure is not limited thereto. For example, the electronic device may transfer messages transmitted and received through any other chat window, messages previously grouped according to chat topics, chat titles, or chat contents, and other messages to another electronic device.

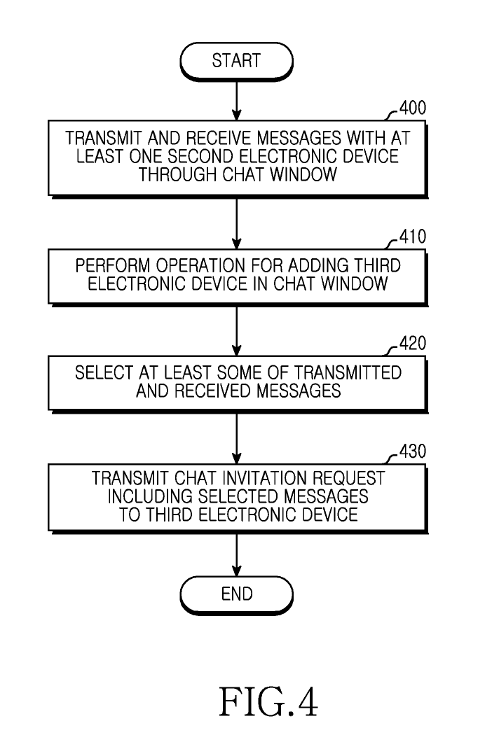

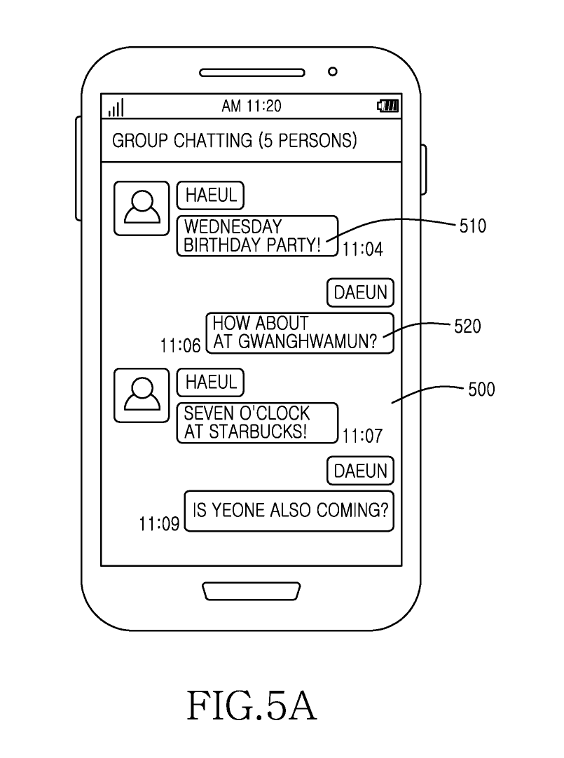

FIG. 4 is a flowchart that illustrates an operational procedure of providing messages transmitted and received with a second electronic device to a third electronic device in an electronic device according to an embodiment of the present disclosure.

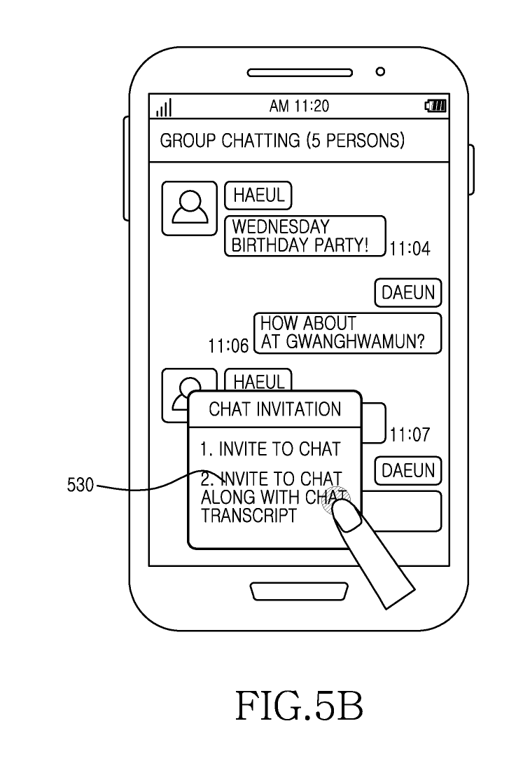

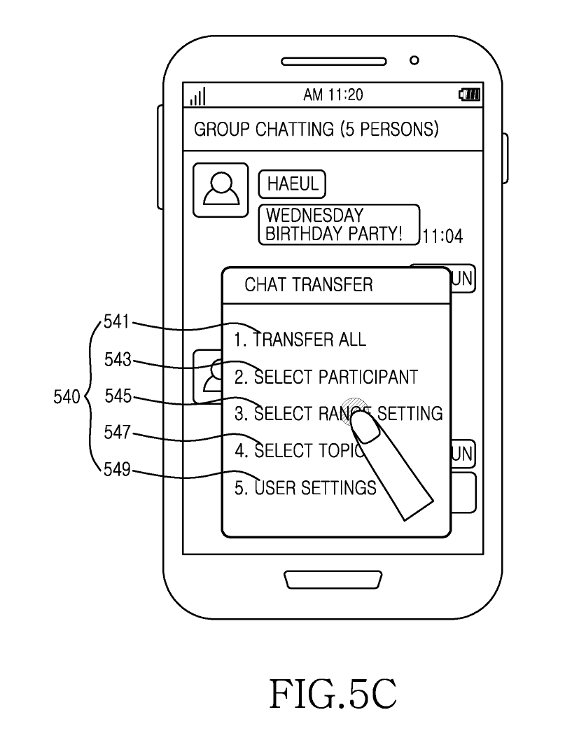

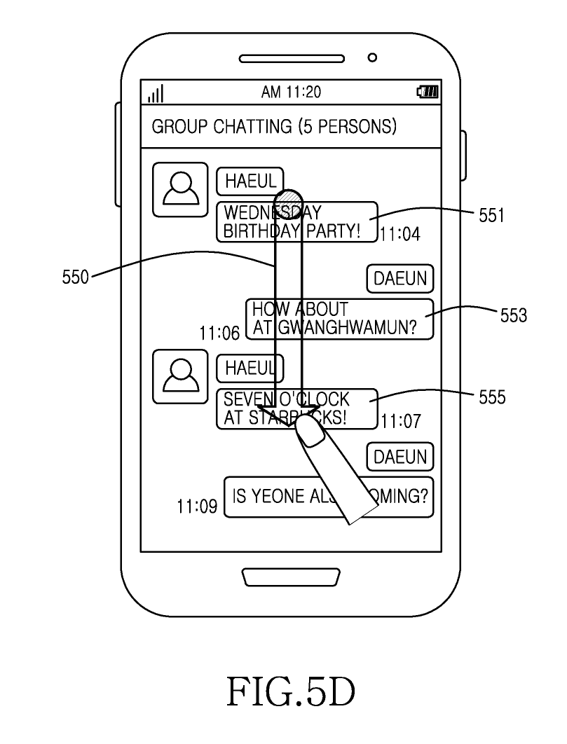

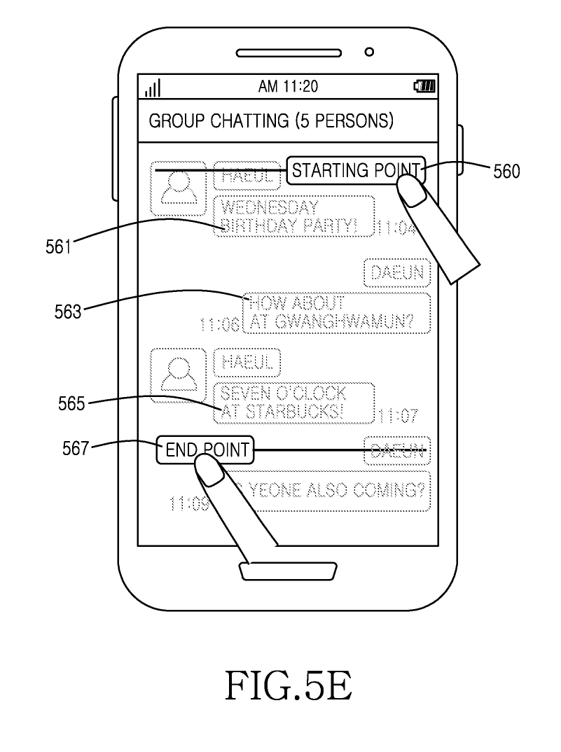

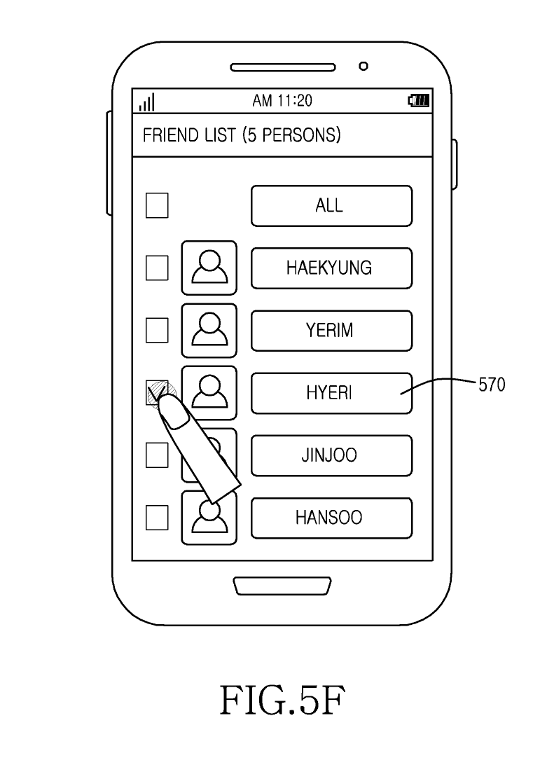

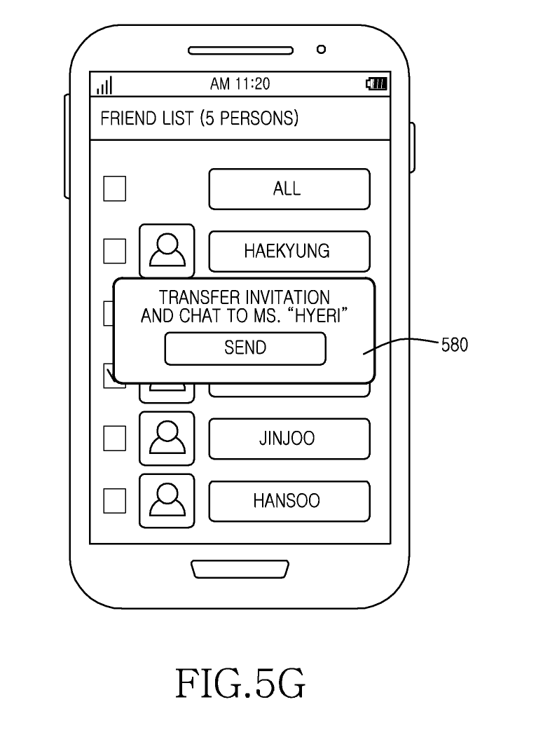

Referring now to FIG. 4, at operation 400, the electronic device may transmit and receive messages with at least one second electronic device through a chat window. Here, the chat window may include a messenger program that enables access to the second electronic device and another electronic device, that is, a third electronic device, but the present disclosure is not limited thereto. For example, as shown in FIG. 5A, the electronic device may receive a message 510 from another electronic device or transmit a message 520 to another electronic device through a chat window 500.

At operation 410, the electronic device may perform an action (e.g., menu, icon, or gesture) for adding a third electronic device in the chat window. In this operation, the electronic device may transmit a chat invitation request along with the messages transmitted and received with the second electronic device. For example, as shown in FIG. 5B, the electronic device may select an action 530 for transmitting a chat invitation request along with a chat transcript. This selected action 530 may invite the invited person to the corresponding chat and at the same time may transfer the previous chat transcript to the invited person to allow the new person to become knowledgeable about the previous chat item.

At operation 420, a user of the electronic device may select at least some of the transmitted and received messages. For example, the electronic device may be operated to select some or all of the messages transmitted and received with the second electronic device according to certain criteria. According to an embodiment of the present disclosure, the electronic device may select messages on the basis of at least one of a chat topic, a chat participant, a message transmission/reception time, the number of messages, and user settings.

For example, as shown in FIG. 5C, in response to user selection the electronic device executes a function 541 for selecting the entire chat transcript, a function 543 for selecting the transcript of a chat with a specific participant, a function 545 for setting the starting point or end point of a chat transcript, a function 547 for selecting the transcript of a chat including a specific topic or specific contents, or a function 549 for selecting a chat transcript through user settings. However, the present disclosure is not limited thereto, and in addition to the above described specific functions 540, there may be functions corresponding to various criteria such as a specific time, a specific place, and the participation time of a specific participant.

As shown in FIG. 5D, for example, when the range selection function 545 is chosen among the specific functions 540, the electronic device may receive, through a user input, a drag 550 over a certain distance and may select messages 551, 553, 555 corresponding to the input drag 550.

Referring now to FIG. 5E, as another example, the electronic device may set a starting point 560 or an end point 567 and may select messages 561, 563, 565 after the starting point 560 or before the end point 567. The starting point 560 or end point 567 may be set by a touch input method, a drag input method, a multi-touch input method, or a method of describing a specific symbol.

At operation 430, in response to user input, the electronic device may transmit a chat invitation request including the selected messages to the third electronic device. According to an embodiment of the present disclosure, the electronic device may determine the third electronic device before or after selecting at least some of the transmitted and received messages.

For example, as shown in FIG. 5F, in response to user input, the electronic device may identify a user selection of a participant 570 to whom to transmit a chat invitation request including the selected messages.

As shown in FIG. 5G, prior to executing the selection of the participant 570, the electronic device may first output a chat invitation confirmation window 580. According to various embodiments of the present disclosure, the electronic device may also transmit a chat invitation request including the selected messages to at least one other electronic device.

Although the electronic device according to various embodiments of the present disclosure has been described as transmitting only messages transmitted and received through a chat window to another electronic device, the present disclosure is not limited thereto. For example, the electronic device may transfer messages transmitted and received through any other chat window, messages that were previously grouped according to chat topics, chat titles, or chat contents, and other messages to another electronic device.

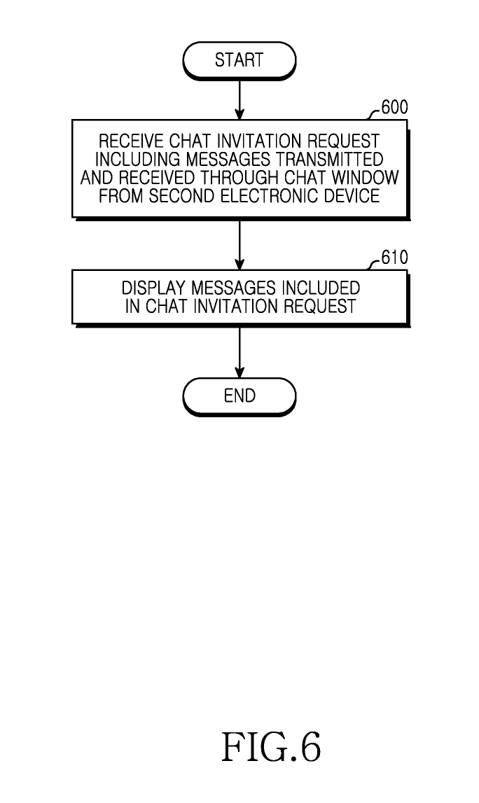

FIG. 6 is a flowchart that illustrates an operative procedure of displaying a chat transcript transferred from another electronic device in an electronic device according to an embodiment of the present disclosure.

Referring now to FIG. 6, at operation 600, the electronic device may receive a chat invitation request including messages transmitted and received through a chat window from a second electronic device. For example, the electronic device may join the chat window and may transmit and receive messages with the second electronic device when accepting the chat invitation request.

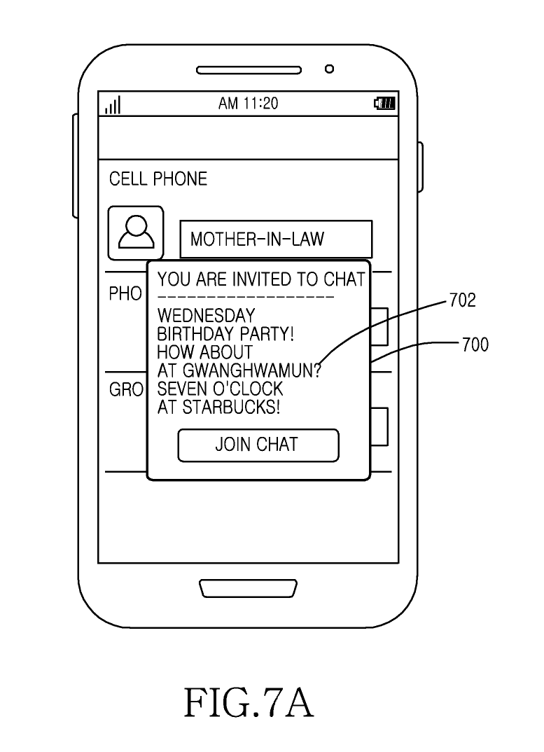

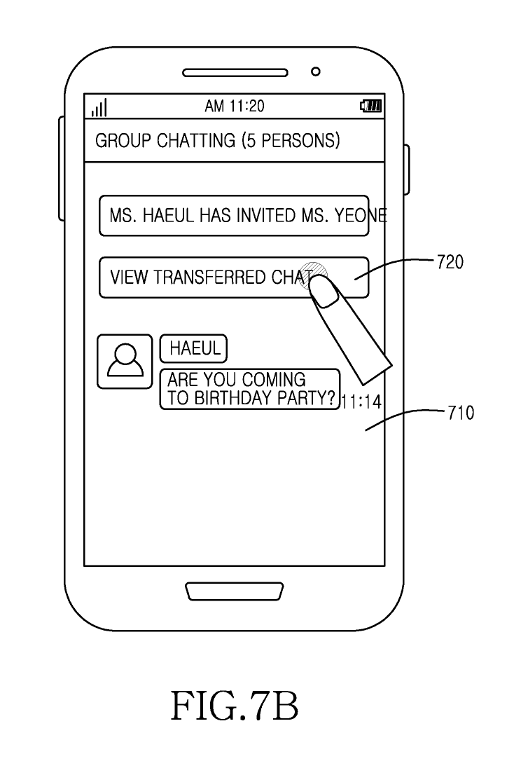

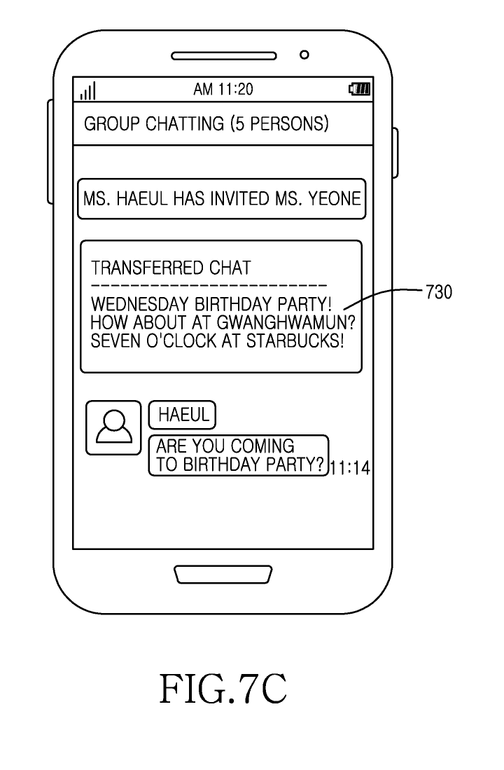

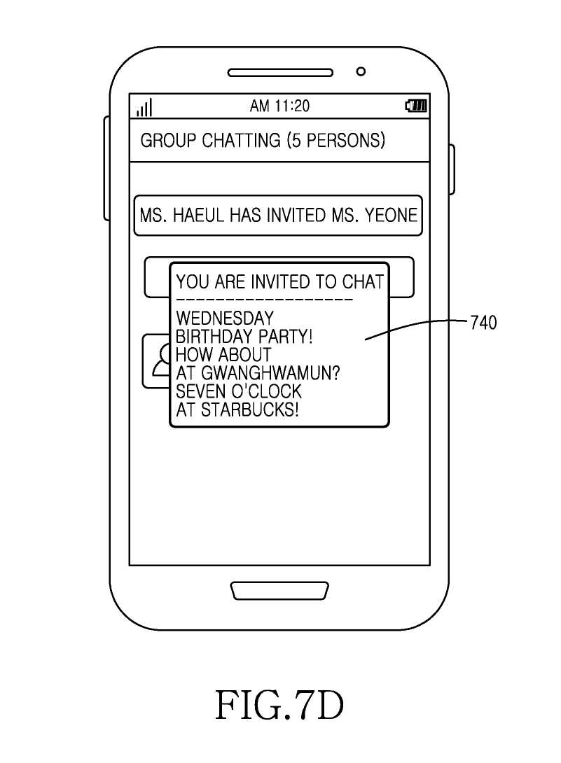

At operation 610, the electronic device may display the messages included in the chat invitation request. According to an embodiment of the present disclosure, as shown in FIG. 7A, the electronic device may display the messages 702 along with the chat invitation request 700. In this case, the electronic device may confirm the previous chat transcript in the chat window to which the electronic device is invited before accepting the chat invitation request 700. According to various embodiments of the present disclosure, when the chat window has a new additional chat transcript before the electronic device accepts the chat invitation request, the electronic device may additionally display the corresponding additional chat transcript in the chat invitation request 700. For example, the electronic device may update the messages 702 included in the chat invitation request 700 in real time (i.e. as they occur without delay introduced) and may display the updated messages 702.

According to various embodiments of the present disclosure, the electronic device may display the messages through a folder, through a link, through a popup, or in at least a partial area of the chat window.

For example, as shown in FIG. 7B, the electronic device may display a view function 720 for viewing the messages in the chat window 710 which the electronic device has joined. As shown in FIG. 7B, when a user touch-selects the view function 720 for viewing the messages, then at FIG. 7C the electronic device may display the messages through a folder 730.

With reference to FIG. 7D, in another example, when the view function 720 for viewing the messages is selected, the electronic device may display the transmitted and received messages through a popup 740. As yet another example, the electronic device may display the messages at the head of the chat window 710. Accordingly, the user of the electronic device may identify various information, such as the specific times, specific users, specific topics of the messages transferred among the previous chatting messages in the chat window 710 though the displayed messages.

FIG. 8 illustrates a block diagram 800 of an electronic device 801 according to various embodiments of the present disclosure. The electronic device 801 may, for example, constitute all or a part of the electronic device 100 shown in FIG. 1. Referring now to FIG. 8, the electronic device 801 may include at least one application processor (AP) 810, a communication module 820, a SIM card 824, a non-transitory memory 830, a sensor module 840, an input unit 850, a display 860, an interface 870, an audio module 880, a camera module 891, a power management module 895, a battery 896, an indicator 897, and a motor 898.

The AP 810 contains circuitry that may control a plurality of hardware or software components connected to the AP 810 and may process various data including multimedia data and perform calculations according to the data processing by driving an operating system or an application program. The AP 810 may, for example, be implemented as a system on chip (SoC). According to an embodiment of the present disclosure, the AP 810 may further include a graphic processing unit (GPU).

The communication module 820, which includes hardware to transmit and receive in various protocols, may transmit and receive data in communication between the electronic device 801 (e.g., the electronic device 100) and any other external device (e.g., the electronic device 104 or the server 164) connected thereto through a network. According to an embodiment of the present disclosure, the communication module 820 may include a cellular module 821, a Wi-Fi module 823, a BT module 825, a GPS module 827, an NFC module 828, and a radio frequency (RF) module 829.

The cellular module 821 may provide a voice call, a video call, a text message service, or an Internet service through a communication network (e.g., LTE, LTE-A, CDMA, WCDMA, UMTS, WiBro, or GSM). Further, the cellular module 821 may perform identification and authentication of electronic devices in a communication network using, for example, a subscriber identification module (e.g., the SIM card 824). According to an embodiment of the present disclosure, the cellular module 821 may perform at least some of functions that may be provided by the AP 810. The cellular module 821 may, for example, perform at least some multimedia control functions.

According to an embodiment of the present disclosure, the cellular module 821 may include a communication processor (CP), which includes hardware circuitry configured for operation. Further, the cellular module 821 may, for example, be implemented as an SoC. Although FIG. 8 shows the elements such as the cellular module 821 (e.g., CP), the memory 830, and the power management module 895 as being separate from the AP 810, the AP 810 may be implemented to include at least some (e.g., the cellular module 821) of the above elements according to an embodiment of the present disclosure.

According to an embodiment of the present disclosure, the AP 810 or the cellular module 821 (e.g., CP) may load a command or data received from at least one of a non-volatile memory and any other element connected to each of the AP 810 and the cellular module 821 into a volatile memory and may process the loaded command or data. Further, the AP 810 or the cellular module 821 may store data received from or generated by at least one of other elements in a non-volatile memory.

The Wi-Fi module 823, the BT module 825, the GPS module 827, or the NFC module 828 may, for example, include a processor for processing data transmitted and received through the corresponding module. Although FIG. 8 shows each of the cellular module 821, the Wi-Fi module 823, the BT module 825, the GPS module 827, and the NFC module 828 as being a separate block, at least some (e.g., two or more) of the cellular module 821, the Wi-Fi module 823, the BT module 825, the GPS module 827, and the NFC module 828 may be included in one integrated chip (IC) or one IC package. For example, at least some of the processors corresponding respectively to the cellular module 821, the Wi-Fi module 823, the BT module 825, the GPS module 827, and the NFC module 828 (e.g., the CP corresponding to the cellular module 821 and the Wi-Fi processor corresponding to the Wi-Fi module 823) may be implemented as one SoC.

With continued reference to FIG. 8, the RF module 829 may transmit and receive data, for example, RF signals. Although not shown in the drawing, the RF module 829 may, for example, include a transceiver, a power amp module (PAM), a frequency filter, a low noise amplifier (LNA), or the like. Further, the RF module 829 may further include additional hardware components for transmitting and receiving an electromagnetic wave in free airspace in wireless communication, for example, a conductor or a conducting wire. Although FIG. 8 shows the cellular module 821, the Wi-Fi module 823, the BT module 825, the GPS module 827, and the NFC module 828 as sharing one RF module 829, at least one of the cellular module 821, the Wi-Fi module 823, the BT module 825, the GPS module 827, and the NFC module 828 may transmit and receive an RF signal through a separate RF module according to an embodiment of the present disclosure.

The SIM card 824 may be a card including a subscriber identification module and may be inserted into a slot formed in a predetermined position of the electronic device. The SIM card 824 may include unique identification information (e.g. an integrated circuit card identifier (ICCID)) or unique subscriber information (e.g., an international mobile subscriber identity (IMSI)).

The non-transitory memory 830 (e.g., the memory 130) may include an internal memory 832 or an external memory 834. The internal memory 832 may, for example, include various hardware, such as at least one of a volatile memory (e.g., DRAM, SRAM, or SDRAM) and a non-volatile memory (e.g., OTPROM, PROM, EPROM, EEPROM, mask ROM, flash ROM, NAND flash memory, or NOR flash memory).

According to an embodiment of the present disclosure, the internal memory 832 may be a solid state drive (SSD). The external memory 834 may further include a flash drive, for example, a CF, a SD, a Micro-SD, a Mini-SD, an xD, a Memory Stick, or the like. The external memory 834 may be functionally connected to the electronic device 801 through various interfaces. According to an embodiment of the present disclosure, the electronic device 801 may further include a storage device (or storage medium) such as a hard drive.

The sensor module 840 includes one or more various sensors that may measure a physical quantity or sense an operative state of the electronic device 801 and may convert the measured or sensed information to an electric signal. The sensor module 840 may, for example, include at least one of a gesture sensor 840A, a gyro sensor 840B, an atmospheric pressure sensor 840C, a magnetic sensor 840D, an acceleration sensor 840E, a grip sensor 840F, a proximity sensor 840G, a color sensor 840H (e.g., a red/green/blue (RGB) sensor), a biometric sensor 840I, a temperature/humidity sensor 840J, a light sensor 840K, and an ultraviolet (UV) sensor 840M. Additionally or alternatively, the sensor module 840 may, for example, include an E-nose sensor, an EMG sensor, an EEG sensor, an ECG sensor, an IR sensor, an iris sensor, a fingerprint sensor, and the like. The sensor module 840 may further include a control circuit for controlling at least one sensor included therein.

The input unit 850 may include a touch panel 852, a (digital) pen sensor 854, a key 856, or an ultrasonic input unit 858. The touch panel 852 that recognizes a touch input may, for example, include at least one of a capacitive touch panel, a resistive touch panel, an infrared touch panel, and an ultrasonic touch panel. The touch panel 852 may further include a control circuit. The capacitive touch panel may be able to recognize physical contact or proximity, and may both be used for operation. The touch panel 852 may further include a tactile layer. In this case, the touch panel 852 may provide a tactile response to a user.

The (digital) pen sensor 854 may be implemented using a means identical or similar to a means for receiving a touch input from a user or using a separate recognition sheet. The key 856 may, for example, include a physical button, an optical key, or a keypad. The ultrasonic input unit 858 may be a unit that can identify data by generating an ultrasonic signal through an input tool and detecting a sonic wave through a microphone (e.g., the microphone 888) in the electronic device 801 and may be capable of wireless recognition. According to an embodiment of the present disclosure, the electronic device 801 may receive a user input from an external device (e.g., computer or server) connected thereto using the communication module 820.

With continued reference to FIG. 8, the display 860 may include a panel 862, a hologram unit 864, or a projector 866. The panel 862 may, for example, be an LCD or an AM-OLED. The panel 862 may, for example, be implemented to be flexible, transparent, or wearable. The panel 862 and the touch panel 852 may be incorporated into one module. The hologram unit 864 may show a stereoscopic image in the air using light interference. The projector 866 may display an image by projecting light onto a screen. The screen may, for example, be located inside or outside of the electronic device 801. According to an embodiment of the present disclosure, the display 860 may further include a control circuit for controlling the panel 862, the hologram unit 864, or the projector 866.

The interface 870 may, for example, include various hardware configured for operation, a high-definition multimedia interface (HDMI) 872, a universal serial bus (USB) 874, an optical interface 876, or a D-subminiature (D-sub) 878. The interface 870 may, for example, be included in the communication unit 160 shown in FIG. 1. Additionally or alternatively, the interface 870 may, for example, include a mobile high-definition link (MHL) interface, a secure digital (SD) card/multi-media card (MMC) interface, or an infrared data association (IrDA) interface.

The audio module 880 includes an audio processor including hardware circuitry configured for operation and may convert a sound and an electrical signal in a bidirectional manner, that is, may convert a sound into an electrical signal and vice versa. The audio module 880 may, for example, process sound information input or output through a speaker 882, a receiver 884, earphones 886, or a microphone 888.

The camera module 891 may be a device that can take both still and/or moving images (video) and may include at least one image sensor (e.g., front sensor or rear sensor; not shown) including but not limited to a CMOS or CCD, a lens (not shown), an image signal processor (ISP) (not shown), or a flash (e.g., LED or Xenon lamp; not shown) according to an embodiment of the present disclosure.

The power management module 895 may manage power of the electronic device 801. Although not shown in the drawing, the power management module 895 may, for example, include hardware configured for operation such as a power management integrated circuit (PMIC), a charger integrated circuit (IC), or a battery or battery gauge. The PMIC may, for example, be mounted in an integrated circuit or an SoC semiconductor.

The charging methods may be classified into, for example, a wired charging and wireless charging. The charger IC may charge a battery and may prevent an overvoltage or excess current from being induced or from flowing from a charger. According to an embodiment of the present disclosure, the charger IC may include a charger IC for at least one of the wired charging and the wireless charging. Examples of the wireless charging may include magnetic resonance charging, magnetic induction charging, and electromagnetic charging, and an additional circuit such as a coil loop, a resonance circuit, and a rectifier may be added for the wireless charging.

The battery gauge may, for example, measure the residual capacity, charge in voltage, current, or temperature of the battery 896. The battery 896 may store or generate electricity and may supply power to the electronic device 801 using the stored or generated electricity. The battery 896 may, for example, include a rechargeable battery or a solar battery.

The indicator 897 may display a specific state of the electronic device 801 or a part thereof (e.g., the AP 810), for example, a boot-up state, a message state, or a state of charge (SOC). The motor 898 may convert an electrical signal into a mechanical vibration. Although not shown in the drawing, the electronic device 801 may include a processing unit (e.g., GPU) for supporting mobile TV. The processing unit for supporting the mobile TV may, for example, process media data pursuant to a certain standard such as digital multimedia broadcasting (DMB), digital video broadcasting (DVB), or media flow.

Each of the above described elements of the electronic device according to various embodiments of the present disclosure may include one or more components, and the name of a corresponding element may vary according to the type of electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

The apparatuses and methods of the disclosure can be implemented in hardware, and in part as firmware or as software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101 and none of the elements are software per se.

The definition of the terms “unit” or “module” as referred to herein are to be understood as constituting hardware circuitry such as a CCD, CMOS, SoC, AISC, FPGA, a processor or microprocessor (a controller) configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

The “module” may, for example, be interchangeably used with the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to various embodiments of the present disclosure may include at least one of an application-specific integrated circuit (ASIC) chip, a field-programmable gate arrays (FPGA), and a programmable-logic device for performing certain operations, which are now known or will be developed in the future.

According to various embodiments of the present disclosure, at least some of the devices (e.g., modules or functions thereof) or methods (e.g., operations) according to various embodiment of the present disclosure may, for example, be implemented by instructions stored in a computer-readable storage medium in the form of a programming module. The instructions, when executed by at least one processor (e.g., the processor 120), enables the at least one processor to perform functions corresponding to the instructions. The computer-readable storage medium may, for example, be the memory 130. At least a part of the programming module may, for example, be implemented (e.g., executed) by the processor 120. At least a part of the programming module may, for example, include a module, a program, a routine, a set of instructions, or a process for performing at least one function.

The computer-readable recording medium may include magnetic media such as a hard disc, a floppy disc, and a magnetic tape; optical media such as a compact disc read only memory (CD-ROM) and a digital versatile disc (DVD); magneto-optical media such as a floptical disk; a hardware device specifically configured to store and execute program instructions (e.g., programming module), such as a ROM, a RAM, and a flash memory. Further, the program instructions may include high level language codes that can be executed by a computer using an interpreter, as well as machine language codes that are made by a compiler. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed in a different order, some of the operations may be omitted, or other operations may be added.

According to various embodiments of the present disclosure, there may be provided a recording medium storing commands for, when executed by at least one processor, causing the at least one processor to perform at least one operation that may include: transmitting and receiving messages with at least one first external electronic device through a chat window; selecting at least some of the transmitted and received messages; and transmitting a chat invitation request including the selected messages to at least one second external electronic device.

The embodiments of the present disclosure disclosed herein and shown in the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of the present disclosure fall within the scope of the present disclosure.

What is claimed is:

1. A method in an electronic device, the method comprising:
transmitting and receiving messages wirelessly through a chat window with at least one first external electronic device;
identifying a selection of at least some of the transmitted and received messages; and
transmitting a chat invitation request including the selected at least some of the transmitted and received messages to at least one second external electronic device.

2. The method of claim 1, further comprising determining the at least one second external electronic device before or after identifying the selection of the at least some of the transmitted and received messages.

3. The method of claim 2, wherein the determining of the at least one second external electronic device comprises determining whether information on the at least one second external electronic device is stored by the electronic device.

4. The method of claim 1, wherein the identifying the selection of the at least some of the transmitted and received messages comprises in response to user a selection, identifying the at least some of the transmitted and received messages based on at least one of a chat topic, a chat participant, a message transmission/reception time, a number of messages, and user settings.

5. The method of claim 4, wherein the identifying the selection of the at least some of the transmitted and received messages based on the chat topic comprises searching for messages associated with a specific word among the transmitted and received messages, messages in other chat windows, or grouped messages.

6. The method of claim 4, wherein the identifying the selection of the at least some of the transmitted and received messages based on the user settings comprises setting a range of the at least some of the transmitted and received messages.

7. The method of claim 6, wherein the setting of the range of the at least some of the transmitted and received messages comprises setting at least one location of the transmitted and received messages in response to detecting a drag over a display of the transmitted and received messages

8. The method of claim 7, wherein the setting of the range of the at least some of the transmitted and received messages comprises setting at least one location of the transmitted and received messages as a starting point or an end point of the range in response to detecting the drag.

9. The method of claim 6, wherein the setting of the range comprises setting at least a time prior to or after one of the transmitted and received messages as a starting point or an end point of the range.

10. An electronic device comprising:
a display module functionally connected to the electronic device; and
a processor configured to control through a chat window of transmitted and received messages with at least one first external electronic device, to identify a selection of at least some of the transmitted and received messages, and to control transmit a chat invitation request including the selected at least some of the transmitted and received messages to at least one second external electronic device.

11. The electronic device of claim 10, wherein the processor is configured to determine whether information regarding the at least one second external electronic device is stored in the electronic device.

12. The electronic device of claim 10, wherein the processor is configured to identify the selection of the at least some of the transmitted and received messages based on a chat topic, a chat participant, a message transmission/reception time, a number of messages, or based on user settings.

13. The electronic device of claim 12, wherein the processor is configured to search for messages associated with a specific word from among the transmitted and received messages, messages in other chat windows, or grouped messages based on the chat topic.

14. The electronic device of claim 12, wherein based on the user settings the processor is configured to set a range of the at least some of the transmitted and received messages.

15. The electronic device of claim 14, wherein the processor is configured to set at least one location of the transmitted and received messages based on a detected a drag over a certain distance.

16. The electronic device of claim 14, wherein the processor is configured to set at least one location of the transmitted and received messages as a starting point or end point of the range.

17. The electronic device of claim 14, wherein the processor is configured to set a time-based range a time prior to or after one of the transmitted and received messages is identified as a starting point or an end point of the range.

18. A method for operating an electronic device, the method comprising:
receiving a chat invitation request including messages from at least one external electronic device; and
displaying the messages included in the chat invitation request.

19. The method of claim 18, wherein the displaying of the messages comprises displaying the messages along with the chat invitation request.

20. The method of claim 18, wherein the displaying of the messages comprises displaying messages using at least one of a folder, a link, and a popup.
